(19) United States
(12) Patent Application Publication
(10) Pub. No.: US 2007/0085829 A1
(43) Pub. Date: Apr. 19, 2007

(54) Methods and portable electronic apparatuses for application program execution

(75) Inventor: Chin Yu Lin, Hsinchu City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/509,851

(22) Filed: Aug. 25, 2006

(30) Foreign Application Priority Data
Oct. 18, 2005 (TW) TW94136328

(51) Int. Cl. G09G 5/08

(52) U.S. Cl. 345/158

(57) ABSTRACT

A method of application program execution performed by a portable electronic apparatus having a display unit is provided. A moving direction of the portable electronic apparatus is detected. A graphic display function is determined according to the moving direction. The determined graphic display function is executed on the display unit of the portable electronic apparatus.

### BACKGROUND

The present invention relates to program execution, and more particularly, to methods and portable electronic apparatuses for application program execution.

Portable apparatuses, such as mobile devices, PDAs (personal digital assistants), MP3 players, portable hard drives, and the like, are designed to be small enough to meet mobility requirements. In order to reduce size, portable apparatuses typically provide a relatively small display screen, and a relatively small keypad for input. Functions provided in application programs are typically triggered, and executed by detecting input signals via the small keypads. Unexpected functions, however, are often executed due to incorrect keystrokes occurring accidentally due to such small keypads.

### SUMMARY

An embodiment of a method of application program execution performed by a portable electronic apparatus having a display unit is provided. A moving direction of the portable electronic apparatus is detected. A graphic display function is determined according to the moving direction. The determined graphic display function is executed on the display unit of the portable electronic apparatus.

The moving direction may be detected by a micro-sensor unit in the portable electronic apparatus. The micro-sensor unit is preferably an accelerometer.

The graphic display function comprise scrolling a first image in left, right, up, or down direction to display other portions of the first image on the display unit, or enlarging or reducing the first image on the display unit. The step of determining the graphic display function may further comprise the following. When the detected moving direction of the portable electronic apparatus is rightward, the first image is scrolled right to display another portion of the first image in the display region. When the detected moving direction of the portable electronic apparatus is leftward, the first image is scrolled left to display another portion of the first image in the display region. When the detected moving direction of the portable electronic apparatus is upward, the first image is scrolled up to display another portion of the first image in the display region. When the detected moving direction of the portable electronic apparatus is downward, the first image is scrolled down to display another portion of the first image in the display region. When the detected moving direction of the portable electronic apparatus is forward, the second image in the display region is enlarged. When the detected moving direction of the portable electronic apparatus is backward, the second image in the display region is reduced.

The method may further comprise the following steps. The portable electronic apparatus detects an acceleration of the portable electronic apparatus. A parameter of the determined graphic display function is determined based on the detected acceleration. The determined graphic display function with the determined parameter is executed. The parameter may be a number of pixels for scrolling the first image, or a multiplier of enlargement or reducing of the second image.

A machine-readable storage medium storing a computer program which, when executed by a portable electronic apparatus having a display unit, performs the method of application program execution is also provided.

Portable electronic apparatuses for application program execution are provided. An embodiment of a portable electronic apparatus comprises a micro-sensor unit, a control unit, and a display unit. The micro-sensor unit detects a moving direction of the portable electronic apparatus. The control unit, coupled to the micro-sensor unit, receives the detected moving direction, determines a graphic display function according to the moving direction, and executes the determined graphic display function. The display unit for displaying an image according to the determined graphic display function. The micro-sensor unit is preferably an accelerometer.

The graphic display functions comprise scrolling a first image in left, right, up, or down direction to display another portion of the first image in a display region, enlarging, or reducing a second image in the display region. The control unit may scroll the first image right to display another portion of the first image in the screen when the detected moving direction of the portable electronic apparatus is rightward. The control unit may scroll the first image left to display another portion of the first image in the display region when the detected moving direction of the portable electronic apparatus is leftward. The control unit may scroll the first image up to display another portion of the first image in the display region when the detected moving direction of the portable electronic apparatus is upward. The control unit may scroll the first image down to display another portion of the first image in the display region when the detected moving direction of the portable electronic apparatus is downward. The control unit may enlarge the second image in the display region when the detected moving direction of the portable electronic apparatus is forward. The control unit may reduce the second image in the display region when the detected moving direction of the portable electronic apparatus is backward.

The micro-sensor unit may further detect an acceleration of the portable electronic apparatus. The control unit may receive the detected acceleration, determine a parameter for the determined graphic display function based on the detected acceleration, and execute the determined graphic display function with the determined parameter. The parameter may be a number of pixels for scrolling the first image, or a multiplier of enlargement, or reducing of the second image.

The micro-sensor unit may comprise an inertial object, springs, a damper, and a conversion unit. The springs suspend the inertial object, when the portable electronic apparatus moves, an acceleration force acts on the inertial object causing the inertial object to deviate from a zero-acceleration position until the restoring force from the springs balances the acceleration force. The conversion unit converts the magnitude of the inertial-object deflection into representative electrical signals of the moving direction and the acceleration.

The portable electronic apparatus may be a mobile device, personal digital assistant, digital music player, portable disk drive, or portal programmable consumer electronic device.

### DESCRIPTION OF THE DRAWINGS

The invention will become more fully understood by referring to the following detailed description with reference to the accompanying drawings, wherein:

FIG. 1 is a diagram of a hardware environment applicable to an embodiment of a mobile device;

FIG. 2 is a diagram of a hardware environment applicable to an embodiment of a micro-sensor unit;

FIGS. 3 and 4 are flowcharts of various embodiments of application program execution methods;

FIGS. 5a to 5g are diagrams illustrating exemplary display images;

FIG. 6 is a diagram illustrating exemplary moving directions;

FIG. 7 is a diagram of a storage medium storing a computer program for application program execution.

### DETAILED DESCRIPTION

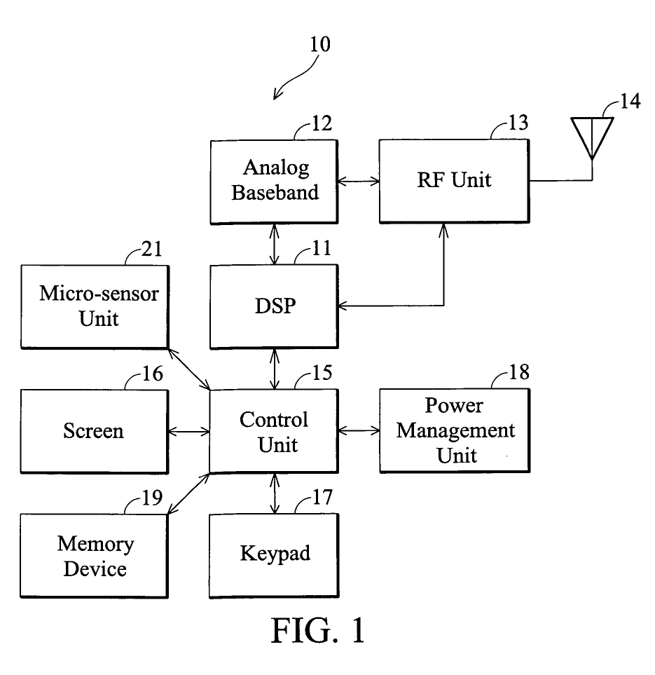

FIG. 1 is a diagram of a hardware environment applicable to an embodiment of a mobile device 10 comprising a DSP (digital signal processor) 11, an analog baseband 12, a RF (Radio Frequency) unit 13, an antenna 14, a control unit 15, a screen 16, a keypad 17, a power management unit 18, a memory device 19, and a micro-sensor unit 21. Moreover, those skilled in the art will understand that some embodiments may be practiced with other portable electronic devices, including personal digital assistants (PDAs), digital music players, portable disk drives, portal programmable consumer electronics, and similar. The control unit 15 may be a micro-processor (MPU) unit loading, and executing application program execution methods from the memory device 19. The memory device 19 is preferably a random access memory (RAM), but may also include read-only memory (ROM), or flash memory, storing program modules.

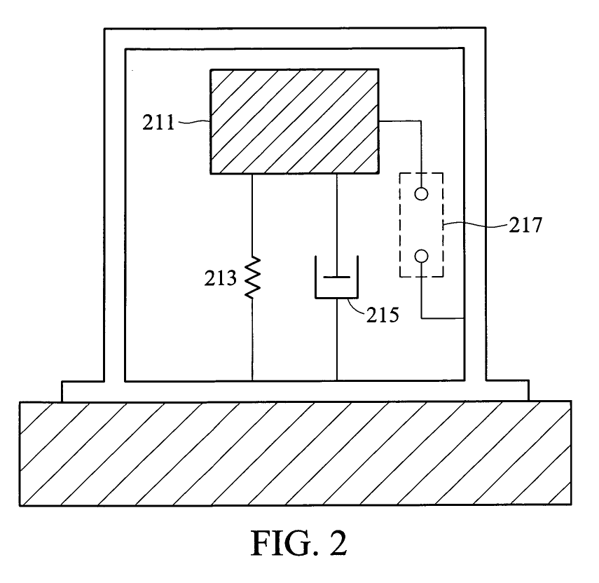

The micro-sensor unit 21, preferably an accelerometer, detects a moving direction, and an acceleration while the mobile device 10 moves. FIG. 2 is a diagram of a hardware environment applicable to an embodiment of the micro-sensor unit 21 comprising an inertial object 211, springs 213, a damper 215, and a conversion unit 217. The inertial object 211 is suspended by springs 213. Under acceleration, a force acts on the inertial object 211 causing the inertial object 211 to deviate from zero-acceleration position until the restoring force from springs 213 balances the acceleration force. The magnitude of the inertial-object deflection is converted into representative electrical signals, which appear at the sensor output, comprising the moving direction and acceleration for the moving mobile device 10.

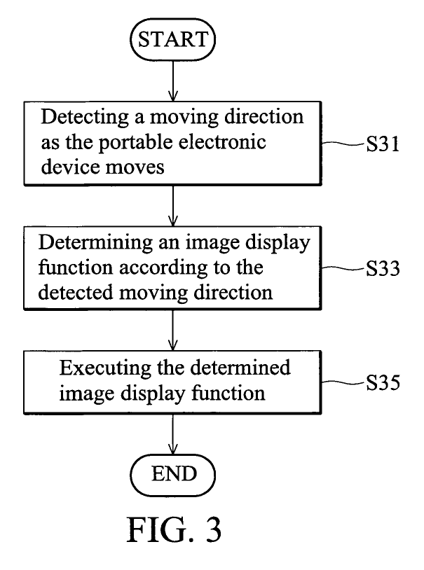

FIG. 3 is a flowchart of an embodiment of an application program execution method, performed by a. control unit of a portable electronic device. In step S31, a moving direction is detected as the portable electronic device moves. In step S33, an image display function is determined according to the detected moving direction. In step S35, the determined image display function is executed.

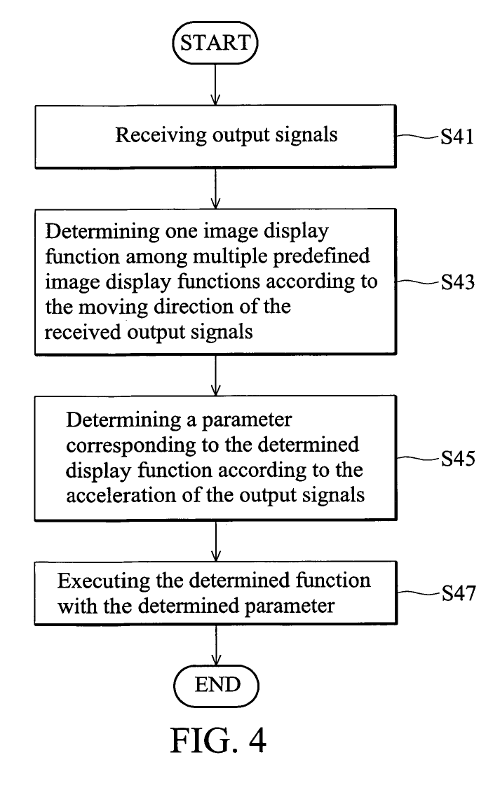

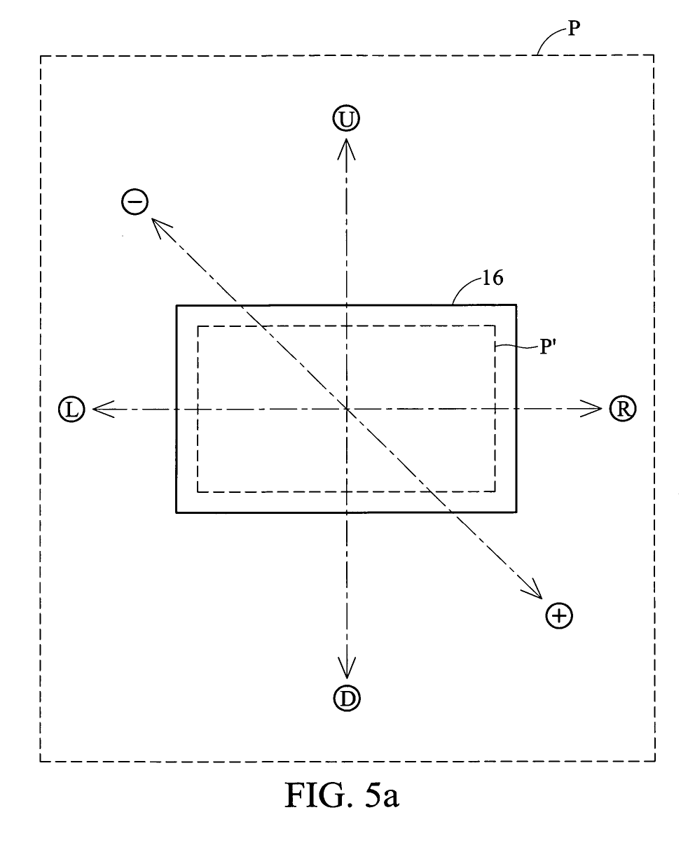

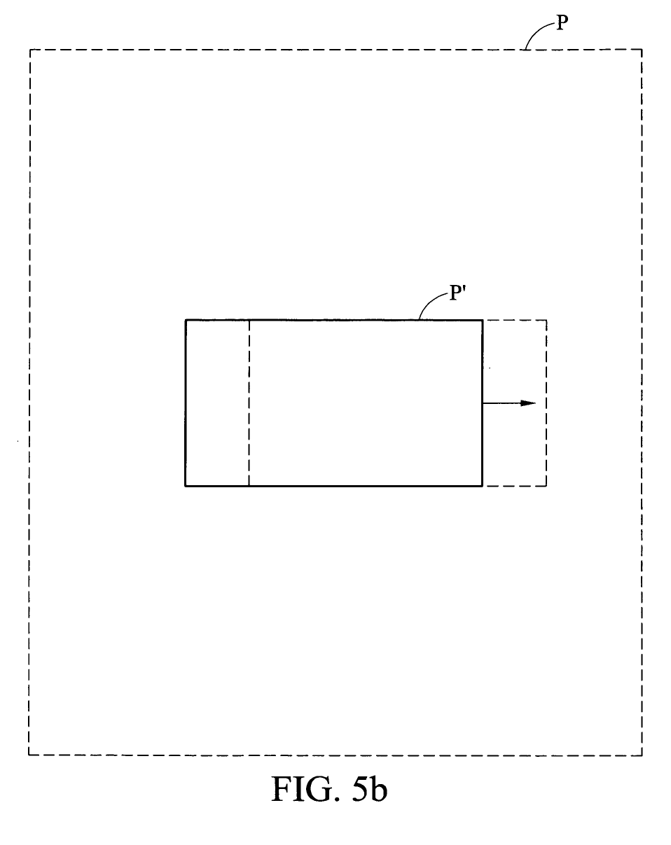

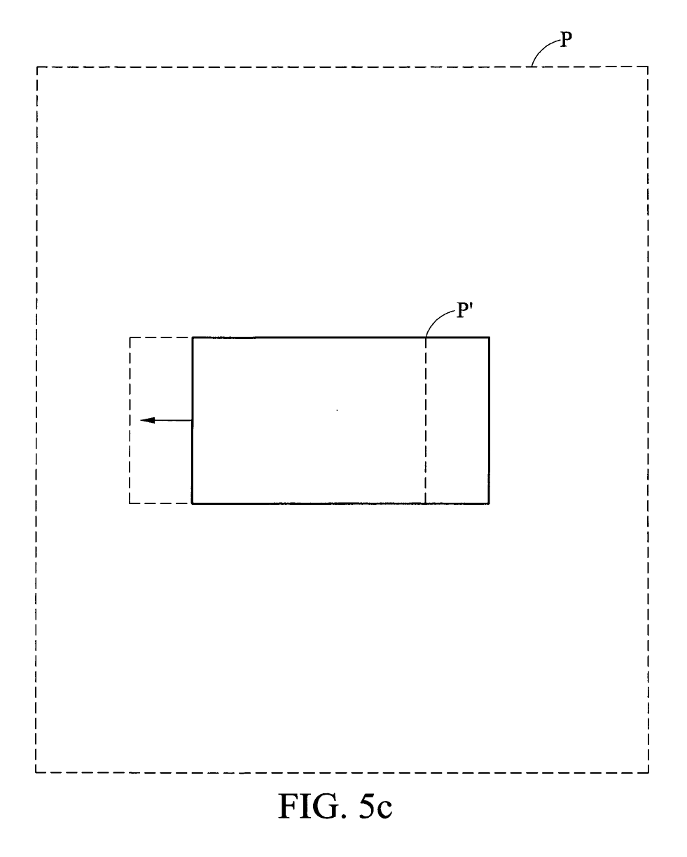

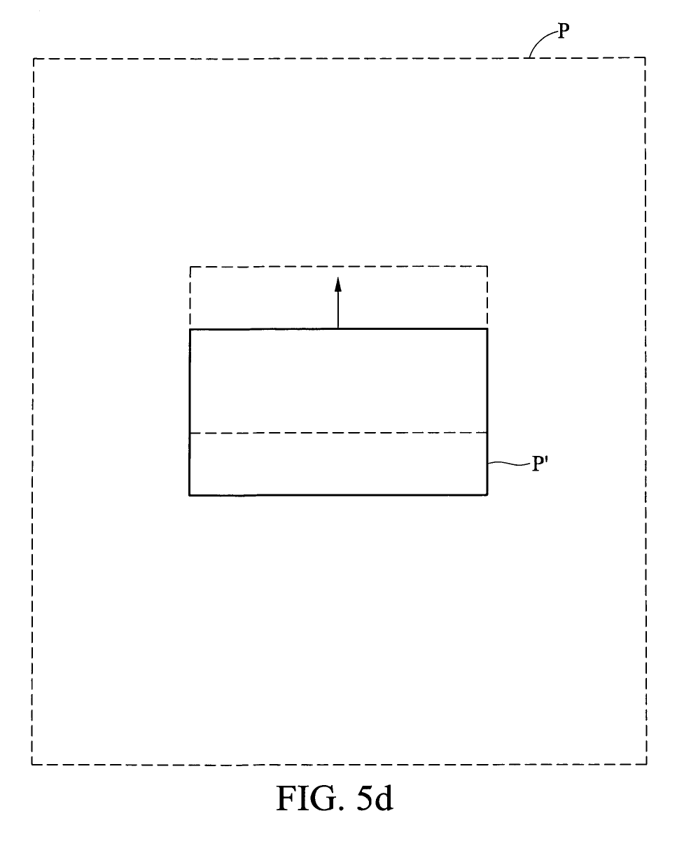

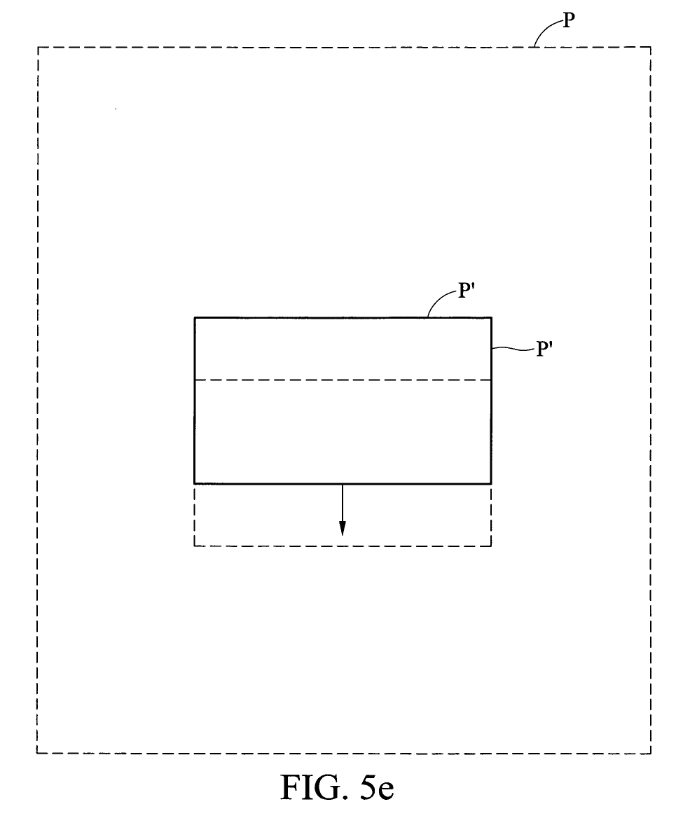

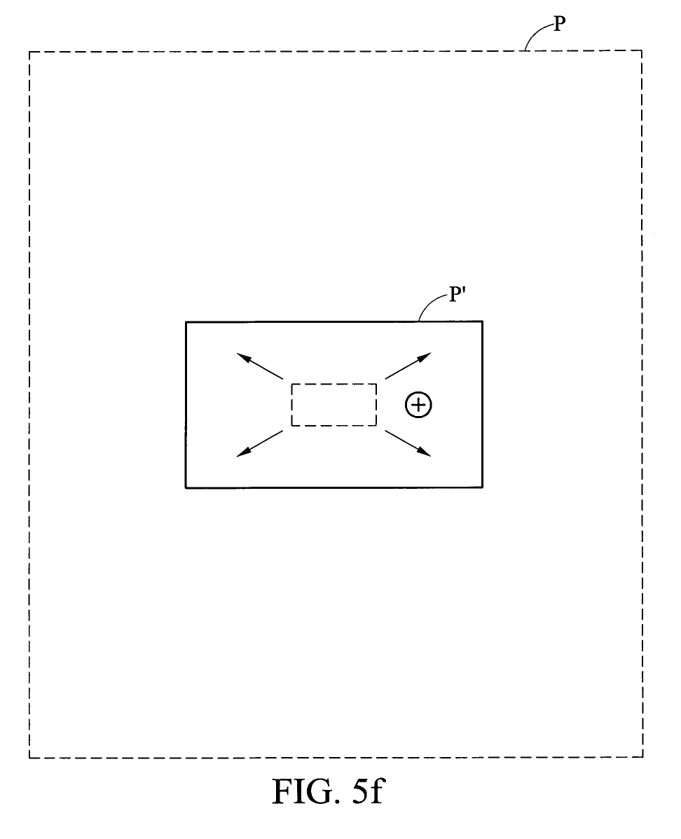

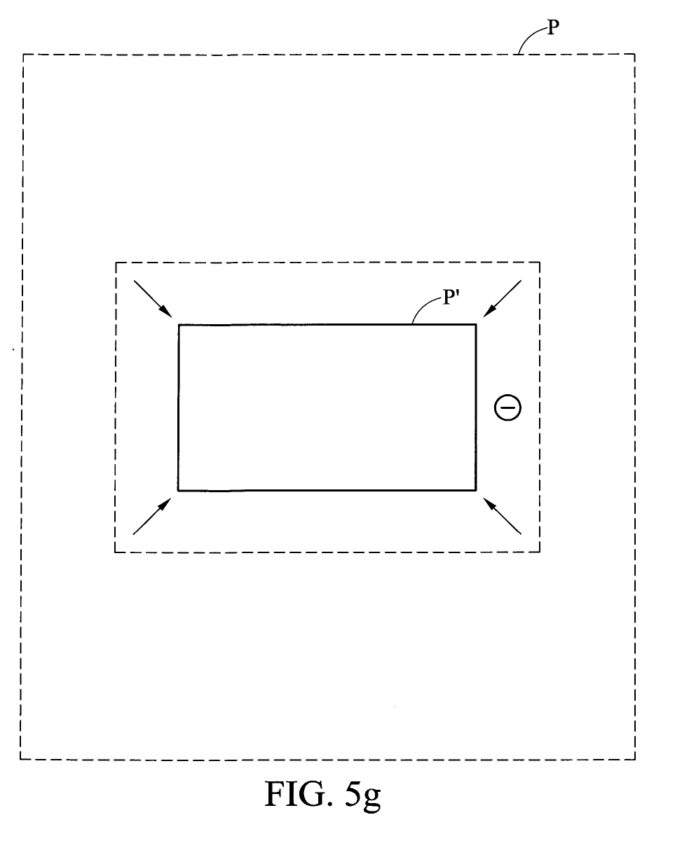

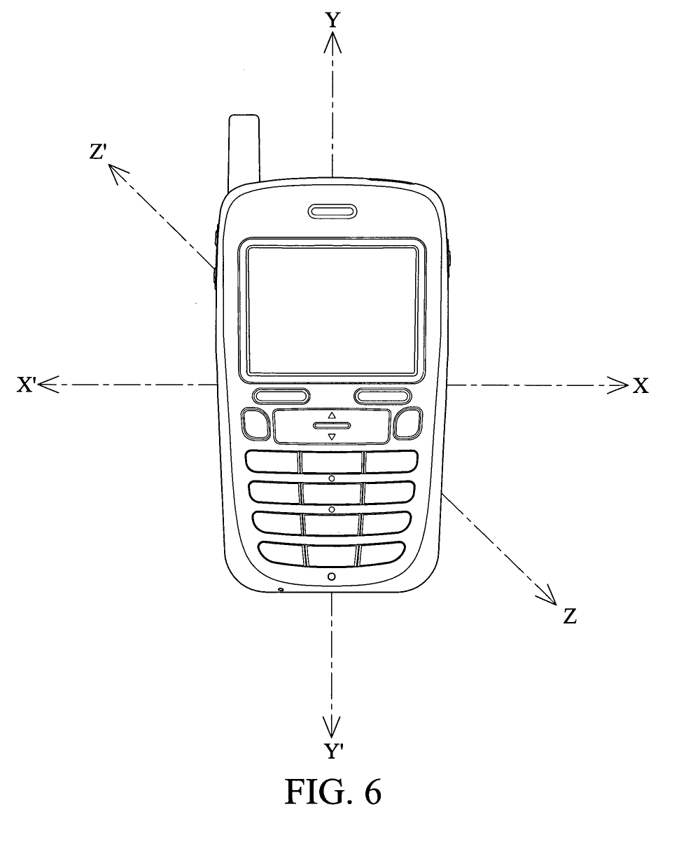

FIG. 4 is a flowchart of an embodiment of an application program execution method, performed by the control unit 15 of the mobile device 10. In step S41, output signals are received from the micro-sensor unit 21, comprising a moving direction and an acceleration. In step S43, one image display function among multiple predefined image display functions is determined according to the moving direction of the received output signals, for example, an image display application program is executed. FIGS. 5a to 5g are diagrams illustrating exemplary display images. Because the screen 16 is not big enough to display the entire display image P, only a portion of the display image P′ (i.e. a display region) can be viewed on the screen 16. Thus, the image display application program provides predefined functions such as rightward, leftward, upward, downward movement, zoom-in, and zoom-out of the displayed image P′ viewed in the display region. FIG. 6 is a diagram illustrating exemplary moving directions. For example, when the received output signals comprise information indicating that the mobile device 10 has moved along the X-axis (i.e. rightward movement), it is determined that the display image P is scrolled a certain number of pixels rightward, enabling the screen 16 to display another portion of the display image, as shown in FIG. 5b. When the received output signals comprise information indicating that the mobile device 10 moves along X′-axis (i.e. leftward movement), it is determined that the display image P is scrolled a certain number of pixels leftward, enabling the screen 16 to display another portion of the display image, as shown in FIG. 5c. When the received output signals comprise information indicating that the mobile device 10 moves along the Y-axis (i.e. upward movement), it is determined that the display image P is scrolled a certain number of pixels upward, enabling the screen 16 to display another portion of the display image, as shown in FIG. 5d. When the received output signals comprise information indicating that the mobile device 10 moves along the Y′-axis (i.e. downward movement), it is determined that the display image P is scrolled a number of certain pixels downward, enabling the screen 16 to display another portion of the display image, as shown in FIG. 5e. When the received output signals comprise information indicating that the mobile device 10 moves along the Z-axis (i.e. forward movement), it is determined that a portion of the display region P′ is to be enlarged, and to fill the entire screen 16, as shown in FIG. 5f. When the received output signals comprise information regarding that the mobile device 10 moves along the Z′-axis (i.e. backward movement), it is determined that a portion of the display image P larger than the display region P′ is to be reduced, and to fill the entire screen 16, as shown in FIG. 5g.

Referring to FIG. 4, in step S45, a parameter corresponding to the determined display function is determined according to the acceleration of the output signals. The parameter may be the determined number of pixels for scrolling (i.e. the scrolled pixels), or a multiplier of enlargement or reduction. The number of scrolled pixels is preferably positively associated with the detected acceleration, and a faster acceleration determines a larger number of scrolled pixels. The multiplier of enlargement or reduction is preferably positively associated with the detected acceleration, and a faster acceleration determines a higher multiplier. In step S47, the determined function with the determined parameter is executed. For example, the display image P is scrolled 10 pixels left, right, up, or down. The central 50 percent of the display region is enlarged, and fills the entire screen 16. A portion of the display image, 200 percent of the display region, is reduced, and fills the entire screen.

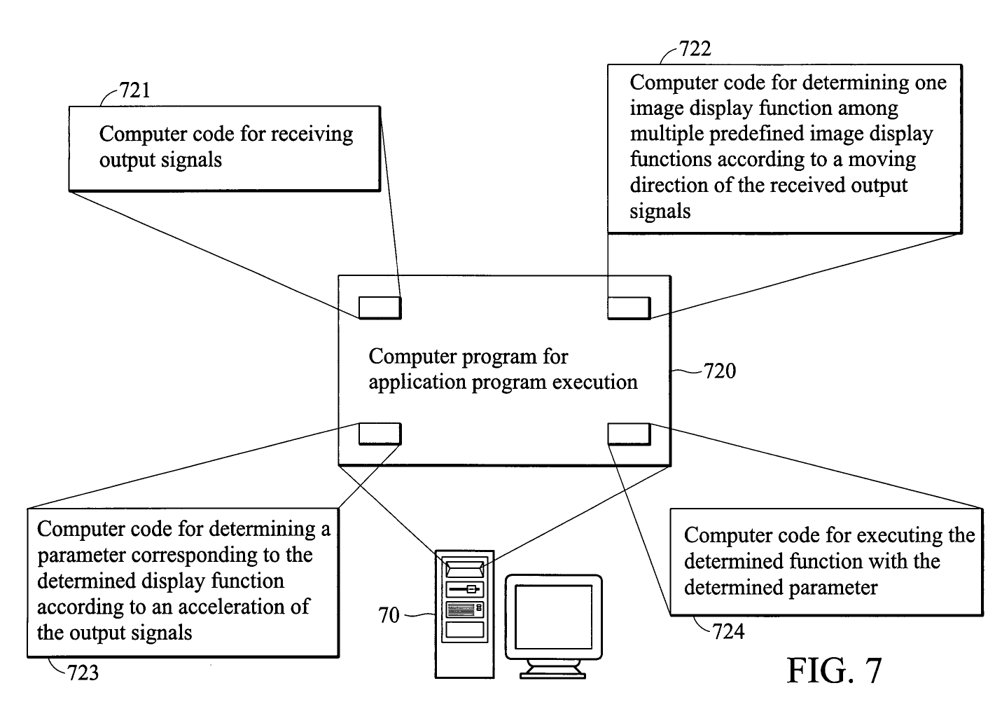

Also disclosed is a storage medium as shown in FIG. 7 storing a computer program 720 providing the disclosed methods for application program execution. The computer program includes a storage medium 70 having computer readable program code therein for use in a computer system. The computer readable program code comprises at least computer readable program code 721 receiving output signals, computer readable program code 722 determining one image display function among multiple predefined image display functions according to a moving direction of the received output signals, computer readable program code 723 determining a parameter corresponding to the determined display function according to the acceleration of the output signals, and computer readable program code 724 executing the determined function with the determined parameter.

Portable electronic apparatuses and methods for application program execution, or certain aspects or portions thereof, may take the form of program code (i.e., instructions) embodied in tangible media, such as floppy diskettes, CD-ROMS, hard drives, nonvolatile memory devices, or any other machine-readable storage medium, wherein, when the program code is loaded into and executed by a machine, such as portable apparatuses and the like, the machine becomes an apparatus for practicing the invention. The disclosed methods and apparatuses may also be embodied in the form of program code transmitted over some transmission medium, such as electrical wiring, or cabling, through fiber optics, or via any other form of transmission, wherein, when the program code is received and loaded into and executed by a portable apparatus, such as a mobile device, or a Personal Digital Assistant (PDA), the machine becomes an apparatus for practicing the invention.

While the invention has been described in terms of preferred embodiment, it is not intended to limit the invention to the precise embodiments disclosed herein. Those who are skilled in this technology can still make various alterations and modifications without departing from the scope and spirit of this invention. Therefore, the scope of the invention shall be defined and protected by the following claims and their equivalents.

What is claimed is:

1. A method of application program execution, performed by a portable electronic apparatus having a display unit, comprising:
detecting a moving direction of the portable electronic apparatus;
determining a graphic display function according to the moving direction; and
executing the determined graphic display function on the display unit of the portable electronic apparatus.

2. The method as claimed in claim 1 wherein the moving direction is detected by a micro-sensor unit in the portable electronic apparatus.

3. The method as claimed in claim 2 wherein the micro-sensor unit is an accelerometer.

4. The method as claimed in claim 1 wherein the graphic display function comprises scrolling a first image left, right, up, or down to display other portions of the first image on the display unit, or enlarging or reducing the first image on the display unit.

5. The method as claimed in claim 4 wherein the the step of determining the graphic display function further comprises:
when the detected moving direction of the portable electronic apparatus is rightward, scrolling the first image rightward to display another portion of the first image in the display region;
when the detected moving direction of the portable electronic apparatus is leftward, scrolling the first image leftward to display another portion of the first image in the display region;
when the detected moving direction of the portable electronic apparatus is upward, scrolling the first image upward to display another portion of the first image in the display region;
when the detected moving direction of the portable electronic apparatus is downward, scrolling the first image downward to display another portion of the first image in the display region;
when the detected moving direction of the portable electronic apparatus is forward, enlarging the second image in the display region; and
when the detected moving direction of the portable electronic apparatus is backward, reducing the second image in the display region.

6. The method as claimed in claim 4 further comprising:
detecting an acceleration of the portable electronic apparatus;
determining a parameter of the determined graphic display function based on the detected acceleration; and
executing the determined graphic display function with the determined parameter.

7. The method as claimed in claim 6 wherein the parameter is a number of pixels for scrolling the first image, or a multiplier of enlargement or reduction of the second image.

8. A machine-readable storage medium for storing a computer program which, when executed by a portable electronic apparatus having a display unit, performs a method of application program execution, the method comprising:
detecting a moving direction of the portable electronic apparatus;
determining a graphic display function according to the moving direction; and
executing the determined graphic display function on the display unit of the protable electronic apparatus.

9. The machine-readable storage medium as claimed in claim 8 wherein the portable electronic apparatus is a mobile device, personal digital assistant, digital music player, portable disk drive, or portable programmable consumer electronic device.

10. A portable electronic apparatus comprising:
a micro-sensor unit for detecting a moving direction of the portable electronic apparatus;
a control unit, coupled to the micro-sensor unit, for receiving the detected moving direction, determining a graphic display function according to the moving direction, and executing the determined graphic display function; and
a display unit for displaying an image according to the determined graphic display function.

11. The portable electronic apparatus as claimed in claim 10 wherein the micro-sensor unit is an accelerometer.

12. The portable electronic apparatus as claimed in claim 10 wherein the graphic display function comprises scrolling a first image left, right, up, or down to display another portion of the first image in a display region, or enlarging or reducing a second image in the display region.

13. The portable electronic apparatus as claimed in claim 12 wherein the control unit scrolls the first image right to display another portion of the first image in the screen when the detected moving direction of the portable electronic apparatus is rightward, scrolls the first image left to display another portion of the first image in the display region when the detected moving direction of the portable electronic apparatus is leftward, scrolls the first image up to display another portion of the first image in the display region when the detected moving direction of the portable electronic apparatus is upward, scrolls the first image down to display another portion of the first image in the display region when the detected moving direction of the portable electronic apparatus is downward, enlarges the second image in the display region when the detected moving direction of the portable electronic apparatus is forward, and reduces the second image in the display region when the detected moving direction of the portable electronic apparatus is backward.

14. The portable electronic apparatus as claimed in claim 13 wherein the micro-sensor unit detects an acceleration of the portable electronic apparatus, and the control unit receives the detected acceleration, determines a parameter for the determined graphic display function based on the detected acceleration, and executes the determined graphic display function with the determined parameter.

15. The portable electronic apparatus as claimed in claim 14 wherein the parameter is a number of pixels by which the first image is to be scrolled, or a multiplier of enlargement or reduction of the second image.

16. The portable electronic apparatus as claimed in claim 14 wherein the micro-sensor unit comprises an inertial object, springs, a damper, and a conversion unit, the springs suspends the inertial object, when the portable electronic apparatus moves, an acceleration force acts on the inertial object causing the inertial object to deviate from zero-acceleration position until the restoring force from the springs balances the acceleration force, and the conversion unit converts the magnitude of the inertial-object deflection into representative electrical signals of the moving direction and the acceleration.

17. The portable electronic apparatus as claimed in claim 10 wherein the micro-sensor unit comprises an inertial object, springs, a damper, and a conversion unit, the springs suspends the inertial object, when the portable electronic apparatus moves, an acceleration force acts on the inertial object causing the inertial object to deviate from the zero-acceleration position until the restoring force from the springs balances the acceleration force, and, the conversion unit converts magnitude of the inertial-object deflection into representative electrical signals of the moving direction.
